(19) United States
(12) Patent Application Publication
(10) Pub. No.: US 2017/0026078 A1
(43) Pub. Date: Jan. 26, 2017

(54) SIGNAL SEPARATION DEVICE AND SIGNAL SEPARATION METHOD

(71) Applicants: NEC Corporation, Tokyo (JP); NEC Engineering, Ltd., Kawasaki-shi (JP)

(72) Inventors: Hiroyuki ISHII, Tokyo (JP); Satoru NEGISHI, Kanagawa (JP)

(73) Assignees: NEC Corporation, Tokyo (JP); NEC Engineering, Ltd., Kawasaki-shi (JP)

(21) Appl. No.: 15/124,947

(22) PCT Filed: Jan. 13, 2015
(86) PCT No.: PCT/JP2015/000099

§ 371 Date: Sep. 9, 2016

(30) Foreign Application Priority Data
Mar. 27, 2014 (JP) 2014-066099

(51) Int. Cl. H04B 3/04; H04B 1/10

(52) U.S. Cl. CPC H04B 3/04; H04B 1/10

(57) ABSTRACT

To separate an interference signal regardless of a power and an arrival direction of the interference signal. A delay adjustment unit acquires a plurality of interference signals comprising identical signal components and synchronizes the predetermined single signal component of each interference signal. A waveform shaping unit adjusts phases of the predetermined single signal components included in the plurality of interference signals the delays of which are adjusted by the delay adjustment unit. An addition unit adds the plurality of interference signals in which the phases of the predetermined single signal components are adjusted by the waveform shaping unit.

### TECHNICAL FIELD

The present invention relates to a signal separation device and a signal separation method.

### BACKGROUND ART

Recently, in a wireless communication system, it is required to improve frequency utilization efficiency for effective use of limited radio wave resources. Therefore, it is desirable that an interference signal in which a plurality of signals mixed in the same frequency is transmitted. In this case, a function easily separating the interference signal is necessary in a receiver.

Further, when each signal component of the interference signal comes from a different direction, the separation of the interference signal based on the arrival direction can be performed. For example, in Patent Literature 1, a method for separating the signal by independent component analysis is disclosed.

Meanwhile, in a Patent Literature 2, a method for bidirectional communication with the same frequency to improve a utilization rate of bandwidth in satellite communication will be disclosed. In the communication method, two ground-based stations transmit signals of the same bandwidth to the same communication satellite and the satellite receives an interference signal in which two signals are mixed. Since the frequency of the interference signal is directly converted and the converted signal is transmitted to the ground-based station, the ground-based station cannot separate the signal based on the arrival directions. Therefore, the ground-based station uses an own transmission signal as a replica of one signal included in the interference signal and separates the signal from the other station by subtracting the replica form the interference signal.

### CITATION LIST

### Patent Literature

Patent Literature 1: Japanese Unexamined Patent Application Publication No. 2008-92363

Patent Literature 2: U.S. Pat. No. 6,859,641

### SUMMARY OF INVENTION

### Technical Problem

However, the inventers have found a problem described below in the above-mentioned methods.

According to Patent Literature 1, the signal separation relies on the direction of the received signals. Therefore, a configuration necessary for direction analysis is required. Further, it cannot be applied to a signal when it is difficult to perform the direction analysis on the signal.

Generally, in order to achieve the bidirectional communication with the same frequency such as Patent Literature 2, it is desirable that there is not a power intensity difference between two signals in the interference signal. Therefore, a transmission power control among communication stations is normally performed to cancel the power intensity difference. In this case, it is difficult to apply the signal separation method based on the power intensity difference such as the signal separation device described above. Further, when the signal separation is performed, a circumstance capable of preparing the replica is not always provided.

The present invention has been made in light of the above situation. An object of the present invention is to separate an interference signal regardless of a power and an arrival direction of the interference signal.

### Solution to Problem

An aspect of the present invention is a signal separation device including: delay adjustment means for acquiring a plurality of interference signals comprising identical signal components and synchronizing a predetermined single signal component of each interference signal; waveform shaping means for adjusting phases of the predetermined single signal components included in the plurality of interference signals the delays of which are adjusted by the delay adjustment means; and addition means for adding the plurality of signals in which the phases of the predetermined single signal components are adjusted by the waveform shaping means and outputting an addition result.

An aspect of the present invention is a signal separation method including: acquiring a plurality of interference signals comprising identical signal components; synchronizing a predetermined single signal component of each interference signal; adjusting phases of the predetermined single signal components included in the plurality of interference signals the delays of which are adjusted, adding the plurality of signals in which the phases of the predetermined one signal components, and outputting the addition result.

### Advantageous Effects of Invention

According to the present invention, it is possible to separate an interference signal regardless of a power and an arrival direction of the interference signal.

### BRIEF DESCRIPTION OF DRAWINGS

FIG. 1 is a block diagram schematically illustrating a configuration of a signal separation device according to a first embodiment.

FIG. 2 is a block diagram illustrating the configuration of the signal separation device according to the first embodiment in more detail.

FIG. 3 is a diagram illustrating a relative delay of signal components commonly included in two interference signals.

FIG. 4 is a diagram illustrating a cross-correlation of the two interference signal.

FIG. 5 is a diagram illustrating timings of the two interference signals at an output stage of a delay adjustment unit.

FIG. 6 is a block diagram schematically illustrating a configuration of a signal separation device according to a second embodiment.

FIG. 7 is a block diagram schematically illustrating a configuration of a signal separation device according to a third embodiment.

FIG. 8 is a block diagram schematically illustrating a configuration of a signal separation device according to a fourth embodiment.

### DESCRIPTION OF EMBODIMENTS

Embodiments of the present invention will be described below with reference to the drawings. The same elements will be assigned the same reference numerals in each drawing, and will not be described when necessary.

### First Embodiment

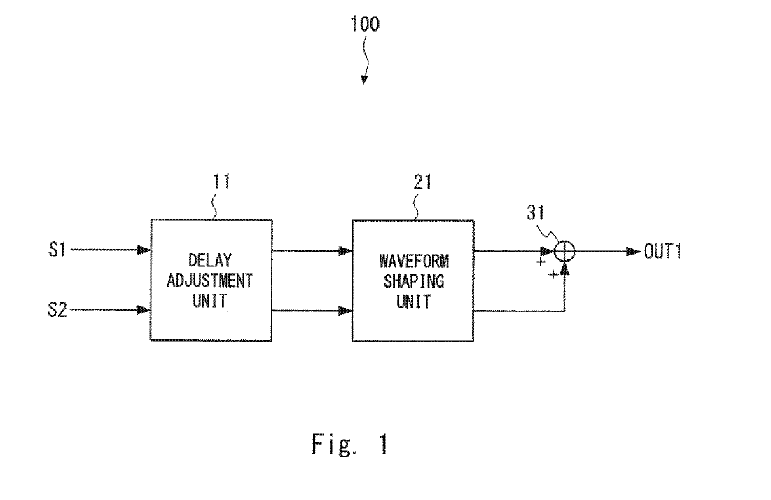

A signal separation device according to a first embodiment will be described. FIG. 1 is a block diagram schematically illustrating a configuration of a signal separation device 100 according to the first embodiment. The signal separation device 100 includes a delay adjustment unit 11, a wave shaping unit 21 and an addition unit 31. The delay adjustment unit, the wave shaping unit and the addition unit are provided as delay adjustment means, wave shaping means and adding means for an interference signal, respectively.

An interference signal S1 (also referred to as a first interference signal) and an interference signal S2 (also referred to as a second interference signal) are input to the delay adjustment unit 11. In the present embodiment, a single interference signal transmitted from the same transmission source reaches the signal separation device 100 via different paths so that the interference signal S1 and the interference signal S2 are generated. Therefore, the interference signal S1 and the interference signal S2 are both the signal representing the same information.

Further, the interference signal S1 and the interference signal S2 include a plurality of signal components. In this example, there are two signal components of a common signal component C1 and a common signal component C2 as signal components commonly included in the interference signal S1 and the interference signal S2. In this case, as the interference signal S1 and the interference signal S2 transmit thorough the different paths, different delays are caused on the interference signal S1 and the interference signal S2, respectively.

The delay adjustment unit 11 can adjust a relative delay between the interference signal S1 and the interference signal S2. In this case, the delay adjustment unit 11 performs a delay adjustment to match timings of the common signal components C1 or the common signal components C2 included in the interference signal S1 and the interference signal S2. In the present embodiment, an example where the delay adjustment unit 11 performs the delay adjustment to match the timings of the common signal components C1 included in the interference signal S1 and the interference signal S2 will be described.

The interference signal S1 and the interference signal S2 the relative delay of which is adjusted by the delay adjustment unit 11 are input to the wave shaping unit 21. The wave shaping unit 21 can synchronize phases of either of the common signal components included in the interference signal S1 and the interference signal S2 which are input. In the present embodiment, an example where the wave shaping unit 21 synchronizes the phases of the common signal components C1 will be described.

The addition unit 31 adds the interference signal S1 and the interference signal S2 in which the phases of either common signal component output from the wave shaping unit 21 are synchronized and outputs the addition result as an output signal OUT1.

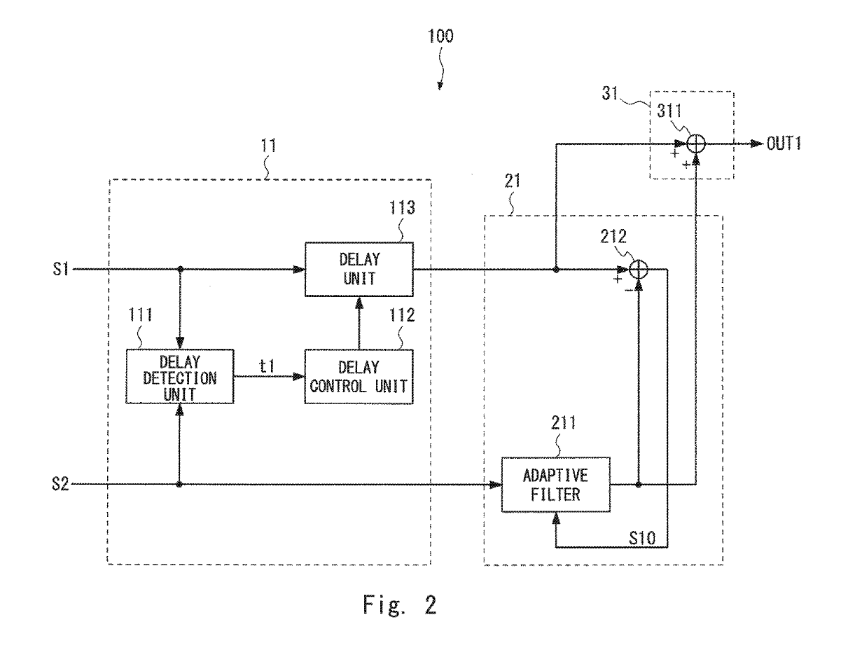

Hereinafter, a specific example of configurations of the delay adjustment unit 11, the wave shaping unit 21 and the addition unit 31 will be described. FIG. 2 is a block diagram illustrating the configuration of the signal separation device 100 according to the first embodiment in more detail. The delay adjustment unit 11 includes a delay detector 111, a delay control unit 112 and a delay unit 113. The delay detector 111, the delay control unit 112 and the delay unit 113 are provided as delay detection means, delay control means and delay means for the interference signal. The delay detector 111 is also referred to as first delay detection means. The delay control unit 112 is also referred to as first delay control means. The delay unit 113 is also referred to as first delay means. The delay detector 111 measures the relative delay between the interference signal S1 and the interference signal S2. The delay unit 113 delays the interference signal S1. The delay control unit 112 controls an amount of delay of the interference signal S1 at the delay unit 113.

The wave shaping unit 21 includes an adaptive filter 211 and a subtractor 212. In this example, the adaptive filter is provided as means for adjusting the phase of the interference signal. The adaptive filter 211 is also referred to as first adjustment means. The subtractor 212 is also referred to as first subtractor. The adaptive filter 211 shapes an output waveform of the interference signal S2. The subtractor 212 subtracts the output of the adaptive filter 211 from the output of the delay unit 113. The output of the subtractor 212 is fed back to the adaptive filter 211. In this example, the adaptive filter 211 controls the phase of the interference signal S2 to minimize a power of the output of the subtractor 212 by adjusting an own filter coefficient.

The addition unit 31 includes an adder 311 that adds the interference signal S1 and the interference signal S2, in which the phases of either common signal component, output from the wave shaping unit 21 are synchronized and outputs the addition result as the output signal OUT1. The adder 311 is also referred to as a first adder.

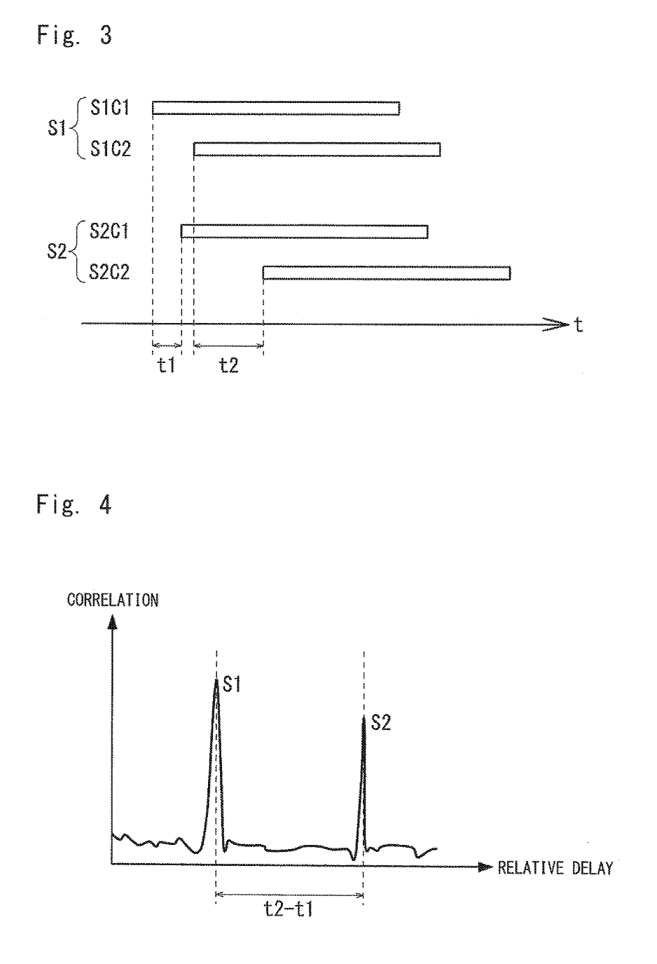

Hereinafter, an operation of the signal separation device 100 will be described. The delay detector 111 measures the relative delay of the signal components commonly included in the interference signal S1 and the interference signal S2. The relative delay will be described below. FIG. 3 is a diagram illustrating the relative delays of the signal components commonly included in the two interference signals. In FIG. 3, the common signal component C1 and the common signal component C2 are included as the signal components commonly included in the interference signal S1 and the interference signal S2. In FIG. 3, the common signal component C1 of the interference signal S1 is indicated as a signal S1C1, the common signal component C2 of the interference signal S1 is indicated as a signal S1C2, the common signal component C1 of the interference signal S2 is indicated as a signal S2C1, and the common signal component C2 of the interference signal S2 is indicated as a signal S2C2. In this example, as illustrated in FIG. 3, the relative delay which is a time lag between the signal S1C1 and the signal S2C1 is referred to as t1 and the relative delay which is a time lag between the signal S1C2 and the signal S2C2 is referred to as t2.

FIG. 4 is a diagram illustrating a cross-correlation of two interference signal. As illustrated in FIG. 4, the common signal component C1 has a strong correlation at the relative delay t1. The common signal component C2 has a strong correlation at the relative delay t2. The delay detector 111 acquires the correlations of the common signal component C1 and common signal component C2, and measures the relative delay from the position at which the strong correlation is acquired. The delay detector 111 outputs the measured relative delays t1 and t2 to the delay control unit 112. In the example of FIG. 4, the delay detector 111 acquires the relative delays t1 and t2 from the peak position of the cross-correlation

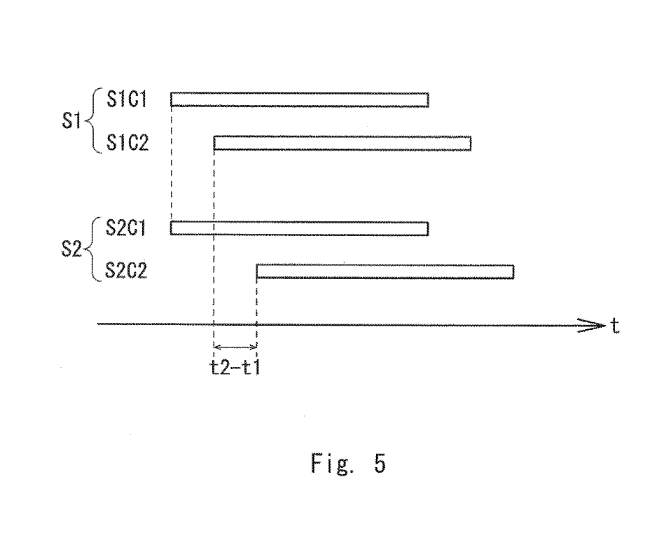

The delay control unit 112 controls the amount of delay of the delay unit 113 based on the relative delays measured by the delay detector 111 to correct the relative delay between the two interference signals. Specifically, the delay control unit 112 controls the amount of delay of the interference signal S1 at the delay unit 113 based on the relative delay t1. In this example, the delay control unit 112 sets the amount of delay at the delay unit 113 to t1. FIG. 5 is a diagram illustrating timings of the two interference signals at an output stage of the delay adjustment unit 11. The interference signal S1 is delayed by t1 by the delay unit 113. Accordingly, the relative delay between the signal S1C1 and the signal S2C1 at the output stage of the delay adjustment unit 11 is zero. Meanwhile, the relative delay between the signal S1C2 and the signal S2C2 is t2-t1.

Next, an operation of the wave shaping unit 21 will be described. Here, the common signal component C1 and the common signal component C2 included in the signal output from the adaptive filter 211, in which the phase and amplitude of the signal S2 are adjusted by the adaptive filter 211, are referred to as a signal S2C1_A and a signal S2C2_A, respectively. In this case, a signal S10 can be namely expressed by the following expression.

S10=S1C1−S2C1_A+S1C2−S2C2_A

As described above, the relative delay between the signal S1C1 and the signal S2C1 at the output stage of the delay adjustment unit 11 is zero, so that there is a strong correlation between the signal S1C1 and the signal S2C1_A. Accordingly, a signal fed back to the adaptive filter 211 from the subtractor 212 is the signal S10 in which the signal S1C1 at the output stage of the delay adjustment unit 11 and the signal S2C1_A output from the adaptive filter 211 interfere with each other.

The adaptive filter 211 adjusts the own filter coefficient to minimize the power of the output of the subtractor 212 (i.e. the signal S10). Minimizing the power of the signal S10 means minimizing an error between the signal S10 and the signal S2C1_A output from the adaptive filter 211 or synchronizing the phases and the amplitudes of the both signals.

The adder 311 adds the signal S1C1 at the output stage of the delay adjustment unit 11 and the signal S2C1_A output from the adaptive filter 211 in a state of phase synchronization. Therefore, the power of the common signal component C1 of the output signal OUT1 is a sum of the power of the signal S1C1 and the power of the S2C1 at the output stage of the delay adjustment unit 11.

Note that the adder 311 further adds the signal S1C2 at the output stage of the delay adjustment unit 11 and the signal S2C2_A output from the adaptive filter 211. However, when an amount of relative delay between the signal S1C2 and the signal S2C2_A is enough larger than a time corresponding to number of taps of the adaptive filter 211, the phases of the signal S1C2 and S2C2 cannot be synchronized with each other. Accordingly, the amplitude of the common signal component C2 is never significantly amplified.

As a result, the signal separation device 100 can substantially separate and derive the common signal component C1 from the common signal component C2.

Note that it is possible to derive the different signal component (the common signal component C2) included in the interference signal using the derived common signal component C1 (the output signal OUT1) and the interference signal.

As described above, according to the present configuration, it can be understood that the predetermined signal component can be derived using a plurality of the interference signal with a simple configuration regardless of the power difference and the arrival direction of the interference signal.

### Second Embodiment

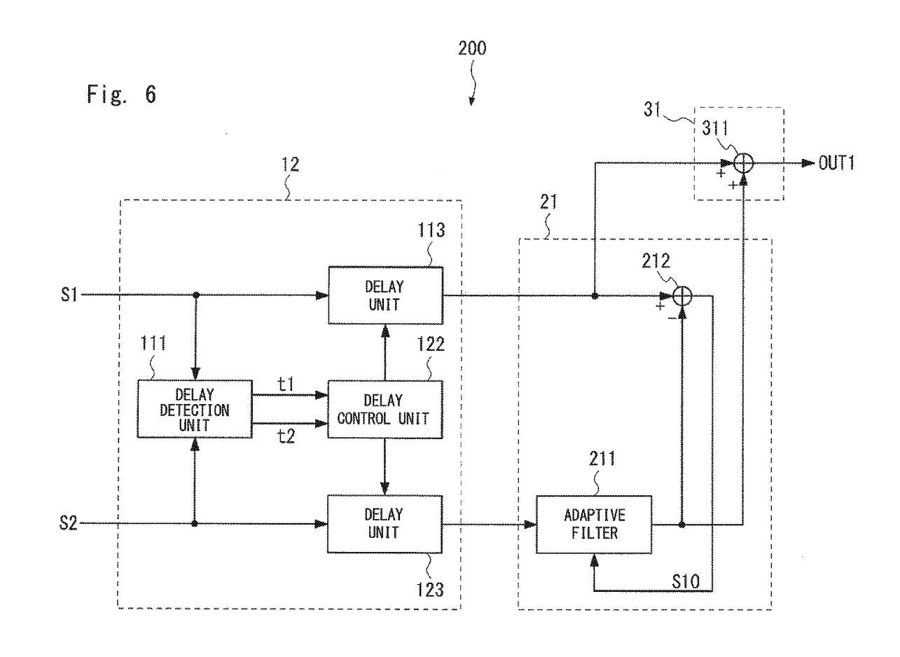

A signal separation device 200 according to a second embodiment will be described. FIG. 6 is a block diagram schematically illustrating a configuration of the signal separation device 200 according to the second embodiment. The signal separation device 200 has a configuration where the delay adjustment unit 11 of the signal separation device 100 is replaced with a delay adjustment unit 12. The delay adjustment unit 12 has a configuration where a delay unit 123 (also as referred to as second delay means) is added to the delay adjustment unit 11 and the delay control unit 112 of the delay adjustment unit 11 is replaced with a delay control unit 122 (corresponding to a second delay control means). Other configuration of the signal separation device 200 is similar to that of the signal separation device 100, so that a description thereof will be omitted.

The delay unit 123 delays the interference signal S2. The delay control unit 122 controls the delay amount of the interference signal S1 at the delay unit 113 and the delay amount of the interference signal S2 at the delay unit 123. That is, the delay control unit 122 controls the delay amounts at the delay unit 113 and the delay unit 123 based on the relative delays measured by the delay detector 111 to correct the relative delay between two interference signals. Specifically, the delay control unit 112 controls the delay amount of the interference signal S1 at the delay unit 113 and the delay amount of the interference signal S2 at the delay unit 123 based on the delay amounts t1 and t2.

In the signal separation device 100 described above, only the delay amount of the interference signal S1 is adjusted. However, in the signal separation device 200, the delay amounts of the both of the interference signal S1 and the interference signal S2. Accordingly, the signal separation device 200 can adjust the delay amount of the interference signal more flexibly as compared with the signal separation device 100.

### Third Embodiment

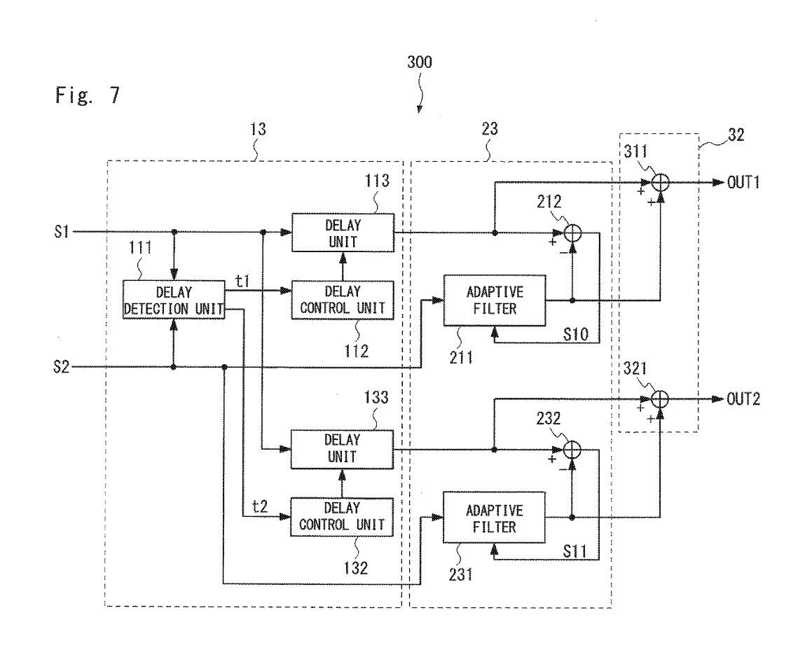

A signal separation device 300 according to a third embodiment will be described. FIG. 7 is a block diagram schematically illustrating a configuration of the signal separation device 300 according to the third embodiment.

The signal separation device 300 has a configuration where the delay adjustment unit 11, the wave shaping unit 21 and the addition unit 31 of the signal separation device 100 are replaced with a delay adjustment unit 13, a wave shaping unit 23 and an addition unit 32, respectively.

The delay adjustment unit 13 has a configuration where a delay unit 133 (also as referred to as second delay means) and a delay control unit 132 (also referred as second delay control means) are added to the delay adjustment unit 11. The delay control unit 132 controls the delay amount of the interference signal S1 at the delay unit 133.

The wave shaping unit 23 has a configuration where an adaptive filter 231 (also referred to as second adjustment means) and a subtractor 232 (also referred to as a second subtractor) are added to the wave shaping unit 21. The adaptive filter 231 and the subtractor 232 correspond to the adaptive filter 211 and the subtractor 212 of the wave shaping unit 21, respectively, and have similar functions thereof. The adaptive filter 231 shapes the output waveform of the multiplexed signal S2. The subtractor 232 subtracts the output of the adaptive filter 231 from the output of the delay unit 133. The output of the subtractor 232 (a signal S11) is fed back to the adaptive filter 231. In this example, the adaptive filter 231 adjusts the phase of the interference signal S2 to minimize the power of the output of the subtractor 232 by adjusting an own filter coefficient.

The addition unit 32 has a configuration where an adder 321 (also referred to as a second adder) is added to the addition unit 31. The adder 321 adds the output of the delay unit 133 and the output of the adaptive filter 231 and outputs the addition result as an output signal OUT2.

An operation of the signal separation device 300 will be described. In the signal separation device 300, the delay control unit 132 of the delay adjustment unit 13 controls the delay amounts of the delay unit 133 based on the relative delay measured by the delay detector 111 to correct the relative delay between two interference signals. Specifically, the delay control unit 132 controls the delay amount of the interference signal S1 at the delay unit 133 based on the relative delay t2. In this example, the delay control unit 132 sets the delay amount of the interference signal to t2. Accordingly, the relative delay between the signal S1C2 and the signal S2C2 at the output stage of the delay unit 133 is zero. Meanwhile, the relative delay between the signal S1C1 and the signal S2C1 is t1-t2.

Operations of the wave shaping unit 23 and the addition unit 32 are similar to the wave shaping unit 21 and the addition unit 31 of the signal separation device 100 and thereby descriptions thereof will be omitted.

In the signal separation device 300, the correlation between the signal S1C2 and the signal S2C2 is strong and those phases are synchronized. Therefore, the power of the common signal component C2 in the output signal OUT2 of the addition unit 32 is a sum of the power of the signal S1C2 and the signal S2C2 at the output stage of the delay adjustment unit 11. Accordingly, the common signal component C2 can be derived at a high power.

As described above, according to the present configuration, it is possible to derive two common signal components from two interference signals and separate those from each other with one signal separation device.

### Fourth Embodiment

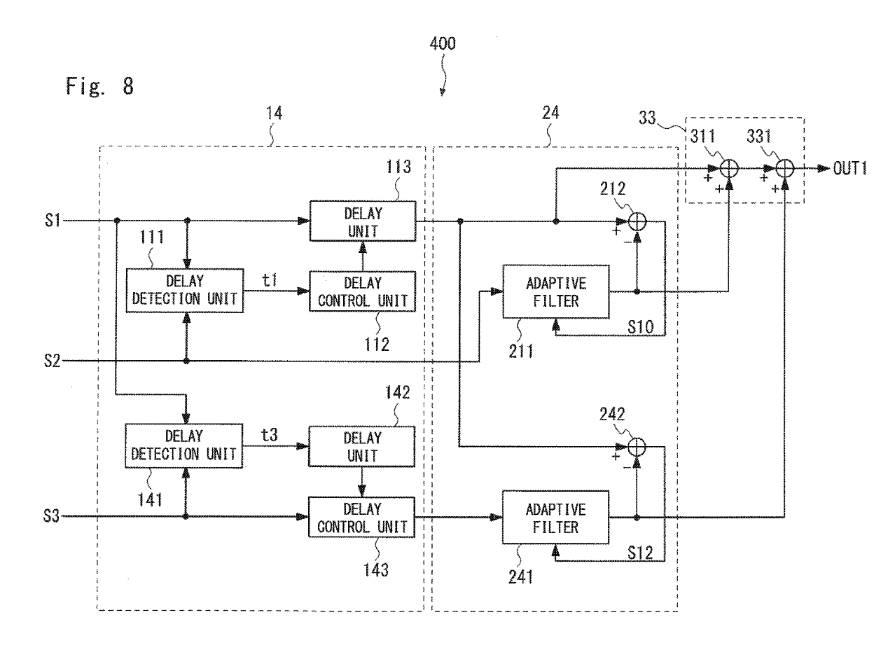

A signal separation device 400 according to a fourth embodiment will be described. FIG. 8 is a block diagram schematically illustrating a configuration of the signal separation device 400 according to the fourth embodiment. The signal separation device 400 has a configuration where the delay adjustment unit 11, the wave shaping unit 21 and the addition unit 31 of the signal separation device 100 are replaced with a delay adjustment unit 14, a wave shaping unit 24 and an addition unit 33, respectively.

The delay adjustment unit 14 has a configuration where a delay detection unit 141 (also referred as second delay detection means) and a delay control unit 142 (also referred as third delay control means) and a delay unit 143 (also referred as third delay means) are added to the delay adjustment unit 11. The delay detection unit 141 measures the relative delay between the interference signal S1 and an interference signal S3. The interference signal S3 is the same signal as the interference signal S3, and a signal reaching the signal separation device 400 via a path different from those of the interference signals S1 and S2. The delay unit 143 delays the interference signal S3. The delay control unit 142 controls the delay amount of the interference signal S3 at the delay unit 143.

The wave shaping unit 24 has a configuration where an adaptive filter 241 (also referred to as third adjustment means) and a subtractor 242 (also referred to as a third subtractor) are added to the wave shaping unit 21. The adaptive filter 241 and the subtractor 222 correspond to the adaptive filter 211 and the subtractor 212 of the wave shaping unit 21, respectively, and have similar functions thereof. The adaptive filter 241 shapes the waveform of the interference signal S3 delayed by the delay unit 142. The subtractor 242 subtracts the output of the adaptive filter 241 from the output of the delay unit 113. The output of the subtractor 242 (a signal S12) is fed back to the adaptive filter 241. In this example, the adaptive filter 241 adjusts the phase of the interference signal S3 to minimize the power of the output of the subtractor 242 by adjusting an own filter coefficient.

The addition unit 33 has a configuration where an adder 331 (also referred to as a third adder) is added to the addition unit 31. The adder 331 adds the output of the adder 311 and the output of the adaptive filter 241, and outputs the addition result as the output signal OUT1.

An operation of the signal separation device 400 will be described. In the signal separation device 400, the delay control unit 142 of the delay adjustment unit 14 controls the delay amounts at the delay unit 143 based on the relative delay measured by the delay detector 141 to correct the relative delay between two interference signals. Specifically, the delay control unit 142 controls the delay amount of the interference signal S3 at the delay unit 143 based on a relative delay t3 of the common signal components C1 of the interference signal S1 and the interference signal S3. Here, the relative delay between the common signal components C2 of the interference signal S1 and the interference signal S3 is t4. In this example, the delay control unit 142 sets the delay amount of the interference signal S3 at the delay unit 143 to t3. Accordingly, the relative delay between the signal S1C1 and the signal S3C1 at the output stage of the delay unit 143 is zero. Meanwhile, the relative delay between the signal S1 C2 and the signal S3C2 is t3-t4. Note that the signal S3C1 reaches the delay adjustment unit 14 earlier than the signal S2C1.

In the wave shaping unit 23, as described above, the adaptive filter 241 and the subtractor 242 correspond to the adaptive filter 211 and the subtractor 212 of the wave shaping unit 21, respectively, and have the similar functions thereof. Therefore, the common signal components C1 of the interference signal S1 and the interference signal S3 are in the state of phase synchronization.

The adder 331 adds the output of the adder 311 (the common signal component C1) and the output of the adaptive filter 241 (the common signal component C1) in the state of phase synchronization.

Other configuration of the signal separation unit 400 is similar to that of the signal separation device 100, and thereby the description thereof will be omitted.

As described above, the signal separation device 400 outputs the addition result of the three interference signals as the output signal OUT1 in a state where one signal component is synchronized. Therefore, the power of the output signal OUT1 can be further increased as compared with the signal separation device 100.

Further, the present invention is not limited to the above-described embodiments, and needless to say, various modifications can be made without departing from the spirit and scope of the present invention described above.

In the third and fourth embodiments, similarly to the second embodiment, two delay units may be provided to adjust each of two interference signals.

Further, the signal separation devices according to the third and fourth embodiments can be combined with each other. That is, it is possible to derive a plurality of signal components and increase the power of the derived signal component.

The subtractor of the embodiments described above is an example. Therefore, the order of the subtraction can be inversed. That is, it may be possible to calculate the power difference between two signals input to the subtractor.

In the embodiments described above, the interference signal input to the subtractor and the interference signal input to the adaptive filter can be replaced with each other.

In the first to third embodiments, the interference signals are not limited to two. A configuration where a single signal component of three or more interference signals and outputs the addition result can be achieved. Further, the signal components included in the interference signal is not limited to two. As long as a signal component of the interference signal to be added is one, the interference signal can include three or more signal components.

Note that, as long as the phase synchronization of on signal component of the interference signal can be achieved, a signal separation device where the waveform shaping unit is omitted can be configured.

Although the present invention is explained above with reference to embodiments, the present invention is not limited to the above-described embodiments. Various modifications that can be understood by those skilled in the art can be made to the configuration and details of the present invention within the scope of the invention.

This application is based upon and claims the benefit of priority from Japanese patent applications No. 2014-66099, filed on Mar. 27, 2014, the disclosure of which is incorporated herein in its entirety by reference.

### REFERENCE SIGNS LIST

11-14 DELAY ADJUSTMENT UNITS
21, 23, 24 WAVEFORM SHAPING UNITS
31-33 ADDITION UNITS
111, 141 DELAY DETECTION UNITS
112, 122, 132, 142 DELAY CONTROL UNIT
113, 123, 133, 143 DELAY UNITS
211, 231, 241 ADAPTIVE FILTERS
212, 232, 242 SUBTRACTORS
311, 321, 331 ADDERS
OUT1, OUT2 OUTPUT SIGNALS
100, 200, 300, 400 SIGNAL SEPARATION DEVICES

What is claimed is:

1.-11. (canceled)

12. A signal separation device comprising:
a delay adjustment unit configured to acquire a plurality of interference signals comprising identical signal components and synchronizing a predetermined single signal component of each interference signal;
a waveform shaping unit configured to adjust phases of the predetermined single signal components included in the plurality of interference signals the delays of which are adjusted by the delay adjustment unit; and
an addition unit configured to add the plurality of interference signals in which the phases of the predetermined single signal components are adjusted by the waveform shaping unit and outputting an addition result.

13. The signal separation device according to claim 12, further comprising a unit configured to acquire a different signal component from the predetermined single signal component included in the interference signal by using the predetermined single signal component and the interference signal.

14. The signal separation device according to claim 12, wherein the waveform shaping unit further adjusts amplitudes of the predetermined single signal components included in the plurality of interference signals the delays of which are adjusted by the delay adjustment unit to adjust an amplitude of the signal output from the addition unit.

15. The signal separation device according to claim 12, wherein
the waveform shaping unit adjusts a phase of one interference signal in the plurality of interference signals output from the delay adjustment unit and outputs the interference signal the phase of which is adjusted, and
the signal separation device comprises a first subtractor configured to output a difference between the interference signal the phase of which is adjusted and one of the plurality of interference signals other than the interference signal the phase of which is adjusted.

16. The signal separation device according to claim 15, wherein
the plurality of interference signals include a first interference signal, and a second interference signal that reaches the delay adjustment unit through a path different from that of the first interference signal,
the waveform shaping unit comprises a first adjustment unit for adjusting one phase of the first interference signal and the second interference signal adjusted by the delay adjustment unit and outputting the adjusted signal, and
the first adjustment unit adjusts the phase or the phase and amplitude of the predetermined single signal component included in the first interference signal or the second interference signal to minimize an amplitude of an output of the first subtractor, and
the addition unit comprises a first adder configured to add one of the first interference signal and the second interference signal that is input to the first subtractor and an signal output from the first adjustment unit, and output the added signal.

17. The signal separation device according to claim 16, wherein
the delay adjustment unit comprises:
a first delay detection unit configured to detect a first relative delay between the predetermined single signal component of the first interference signal and the predetermined single signal component of the second interference signal;
a first delay unit configured to delay one or both of the first interference signal and the second interference signal; and
a first delay control unit configured to control a delay of either or both of the first interference signal and the second interference signal at the first delay unit based on the detected first relative delay.

18. The signal separation device according to claim 17, wherein
the delay adjustment unit adjusts the delay of one or both of the first interference signal and the second interference signal such that a delay between second signal components other than the first signal components does not occur, the first signal components being the predetermined single signal components included in the first interference signal and the second interference signal,
the waveform shaping unit synchronizes the phases of the second signal components included in the first interference signal and the second interference signal the delays of which are adjusted such that the delay between the second signal components does not occur, and
the addition unit adds the first interference signal and the second interference signal the phases of the second signal components of which are synchronized by the waveform shaping unit, and further outputs the added signal.

19. The signal separation device according to claim 18, wherein
the first delay detection unit further detects a second relative delay between the second signal component of the first interference signal and the second signal component of the second interference signal,
the delay adjustment unit further comprises:
a second delay unit configured to delay one or both of the first interference signal and the second interference signal; and
a second delay control unit configured to control the delay of one or both of the first interference signal and the second interference signal at the second delay unit based on the detected second relative delay,
the waveform shaping unit further comprises:
a second adjustment unit for adjusting the phase of one of the first interference signal and the second interference signal the delays of which are adjusted such that the delay between the second signal components does not occur, and outputting the adjusted signal; and
a second subtractor configured to output a difference between the other of the first interference signal and the second interference signal the delays of which are adjusted such that the delay between the second signal components does not occur and the signal output from the second adjustment unit,
the second adjustment unit adjusts the phase or the phase and amplitude of the second signal component included in the first interference signal or the second interference signal to minimize an amplitude of an output of the second subtractor, and
the addition unit comprise a second adder configured to add one of the first interference signal and the second interference signal, the delays of which are adjusted, which is input to the second subtractor, such that the delay between the second signal components does not occur, and the signal output from the second adjustment unit.

20. The signal separation device according to claim 18, wherein
the plurality of interference signals include a third interference signal other than the first interference signal and the second interference signal,
the delay adjustment unit adjusts a delay one or both of the first interference signal and the third interference signal such that a delay between the predetermined single signal components included in the first interference signal and the third interference signal does not occur;
the waveform shaping unit synchronizes phases of the second signal components included in the first interference signal and the third interference signal the delays of which are adjusted by the delay adjustment unit, and
the addition unit adds a signal obtained by adding the first interference signal and the third interference signal the predetermined single signal components of which are synchronized by the waveform shaping unit and the signal obtained by adding the first interference signal and the second interference signal the predetermined single signal components of which are adjusted by the waveform shaping unit, and output the added signal.

21. The signal separation device according to claim 20, wherein
the plurality of interference signals include a third interference signal other than the first interference signal and the second interference signal,
the delay adjustment unit comprises:
a second delay detection unit configured to detect unit a third relative delay between the predetermined single signal component of the first interference signal and the predetermined single signal component of the third interference signal;
a third delay unit configured to delay one or both of the first interference signal and the third interference signal; and
a third delay control unit configured to control a delay of one or both of the first interference signal and the third interference signal at the third delay unit based on the detected third relative delay,
the waveform shaping unit comprises:
a third adjustment unit configured to adjust the phase of one of the first interference signal and the third interference signal adjusted by the delay adjustment unit and outputting the adjusted signal, and
a third adder configured to output a difference of the other of the first interference signal and the third interference signal adjusted by the delay adjustment unit and the signal output from the third adjustment unit,
the third adjustment unit adjusts the phase or the phase and amplitude of the predetermined single signal component included in the first interference signal or the third interference signal to minimize an amplitude of an output of the third subtractor, and
the addition unit further comprises a third adder configured to add the output of the first adder and the signal output from the third adjustment unit and output the added signal.

22. A signal separation method comprising:
acquiring a plurality of interference signals comprising identical signal components;
synchronizing a predetermined single signal component of each interference signal;
adjusting phases of the predetermined single signal components included in the plurality of interference signals the delays of which are adjusted,
adding the plurality of interference signals in which the phases of the predetermined one signal components, and
outputting the addition result.
